(19) United States
(12) Patent Application Publication
(10) Pub. No.: US 2007/0056298 A1
(43) Pub. Date: Mar. 15, 2007

(54) Automated fault detection system for local monitoring of residential and commercial air conditioning systems

(76) Inventors: Julius Stalin Baker, Dallas, TX (US); Carl A. Fiorletta, Dallas, TX (US)

Correspondence Address: Carl Fiorletta, 4600 Versailles Lane, Plano, TX, 75093, US

(21) Appl. No.: 11/224,639

(22) Filed: Sep. 13, 2005

(51) Int. Cl. G01K 13/00

(52) U.S. Cl. 62/129

(57) ABSTRACT

An electronic monitoring system is provided to monitor for and sense faults in a residential or commercial air conditioning system that uses a chemical refrigerant. By monitoring the discharge pressure variable, a determination may be made concerning the condition of the air conditioning system and alert the home owner or resident when the air conditioning system requires professional service. The early warning of system air conditioning system faults will give the property owner the opportunity to service the system before more long term damage is done to the system. The microprocessor based control will monitor the discharge line pressure and transmit a signal to a system monitor panel that is co-located with the heating/air conditioning thermostat installed within the dwelling or structure. A display on the face of the monitor panel will alert the home owner or resident, in an incremental manner, when the air conditioning system is in urgent need of professional service. The system consists of a control module that is installed within the condenser housing, a pressure switch with a variable output that is installed in the condenser discharge line and a display panel that is mounted within the dwelling, next to the thermostat that is controlling the condenser. The communication line between the control of the instant invention and its display panel is the same control line that exists between the system thermostat and the condenser, thereby eliminating the need for a separate control cable or radio frequency control link between the condenser and the interior of the structure.

### BACKGROUND OF THE INVENTION

An air conditioner in a residence or commercial property is able to cool a building because it removes heat from the indoor air and transfers it outdoors. A chemical refrigerant in the system absorbs the unwanted heat and pumps it through a system of piping to the outside coil. The fan, located in the outside unit, blows outside air over the hot coil, transferring heat from the refrigerant to the outdoor air.

Basic Operation: Most air conditioning systems consist of the following five (5) components:
1. a compressor
2. an expansion valve or orifice tube as a refrigerant metering device at the evaporator coil
3. an evaporator coil and blower
4. a condensing coil and blower
5. a chemical refrigerant

### DESCRIPTION OF THE RELATED ART

A number of ideas have been put forth for the monitoring of air conditioning systems.

U.S. Pat. No. 6,772,096, issued to Murakami; Takashi (Kyoto, JP); Shintani; Yasuyuki (Nishinomiya, JP); Nagamitsu; Sachio (Kyoto, JP) on Aug. 3, 2004, and assigned to Matsushita Electric describes a remote maintenance system that communicates to a home server over a long distance communication network. This is not a local monitoring system, as described in the instant invention.

U.S. Pat. No. 6,738,014, issued to Ueda; Hiroyuki (Shimizu, JP); Satou; Keiji (Fujikawa, JP); Mochizuki; Masamichi (Fujinomiya, JP); Sugiyama; Tatsuya (Shizuoka, JP) on May 18, 2004 and assigned to Hitachi Electric, is a service system for an air conditioner connected through a network to a monitoring center, the air conditioner receives radio wave transmitted from a GPS satellite to transmit information of the received radio wave and a manufacturer's serial number on the air conditioner to the monitoring center and the monitoring center performs service of the air conditioner on the basis of the received information and the serial number. This varies considerably from the local monitoring system described in the instant invention.

U.S. Pat. No. 6,736,328, issued to Takusagawa; Masaru and assigned to the Kitz Corporation, is a facility control system that includes a central monitoring unit for monitoring the overall states of facilities in a building, a plurality of facility control units for managing air-conditioners, illumination equipment, disaster prevention equipment and so on in individual rooms, and a control panel used for issuing various commands. The central monitoring unit communicates with the facility control units in accordance with predetermined communication protocol, thereby controlling the devices. Each facility control unit has an output section which is connected to air-conditioners, illumination equipment, disaster prevention equipment and so on, and has an input section which is connected to devices such as room temperature sensors. The facility control units control the operation of the devices connected to the output section on the basis of signals inputted by the input devices and the control panel. In comparison to the instant invention, this patent also describes a large scale, multi systems and multi-facility monitoring system.

U.S. Pat. No. 6,647,317, issued to Takai; Tadashi and the Hitachi Air Conditioning Systems Co., Ltd on Nov. 11, 2003, describes an open network environment and a multi vendor system for an air conditioner is realized so that management and services can be made highly efficient. A management system for an air conditioner has a status database for storing collected running data, and a setting database for storing setting data of the air conditioner, the setting data including data regarding a running stop state, a running mode, an air quantity and a temperature, respectively of the air conditioner, wherein the running data stored in the status database is read to monitor the air conditioner and the setting data is rewritten to control the air conditioner. In this system, a personal computer and a USB communication network is required to collect and transfer air conditioner system data to a database. The database information is then sent to a monitor center, in HTML format, via a Web server.

Most central air conditioning units operate by means of a split system. That is, they consist of a “hot” side, or the condensing unit—including the condensing coil, the compressor and the fan—which is situated outside the residence, and a “cold” side that is located within the residence. The cold side consists of an expansion valve and a cold coil, and it is usually part of the furnace or some type of air handler. The furnace blows air through an evaporator coil, which cools the air. Then this cool air is routed throughout the home or structure by means of a series of air ducts.

The compressor, which is located outdoors, within the condensing unit, is controlled by the thermostat, which is located within the structure to monitor the interior temperature. The compressor, acts as the pump, causing the refrigerant to flow through the system. Its job is to draw in a low-pressure, low-temperature, refrigerant in a gaseous state and by compressing this gas, raise the pressure and temperature of the refrigerant. This high-pressure, high-temperature gas then flows through the condenser coil. The condenser coil is a series of piping with a fan that draws outside air across the coil. As the refrigerant passes through the condenser coil and the cooler outside air passes across the coil, the air absorbs heat from the refrigerant which causes the refrigerant to condense from a gaseous state to a liquid state. Under high-pressure, liquid refrigerant reaches the expansion valve (or orifice tube) located at the inlet of the evaporator (cold) coil. The expansion valve or orifice tube, depending on the design of the evaporator, meters the liquid refrigerant into the evaporator coil. As the liquid refrigerant exits the expansion valve or the orifice tube it (the liquid refrigerant) enters a low pressure area within the evaporator coil, which causes the refrigerant to expand to a low-pressure, low-temperature gas. This “cold” refrigerant flows into the evaporator coil. The evaporator coil is a series of piping connected to a furnace or air handler that blows indoor air across it, causing the coil to absorb heat from the indoor air. The cooled or refrigerated air is then delivered to the house or structure through ducting. The refrigerant (now in a gaseous state) then flows back to the compressor where the cycle starts over again, whereby the compressor and condensing coil returns the gaseous refrigerant to a liquid.

The purpose of the instant invention is to monitor the overall health of the air conditioning system and provide an early warning to the resident or home owner that service is required to maintain optimum operation of the air conditioning system. By monitoring the discharge pressure of the compressor and condensing unit, the home owner may be given an early warning that one or more components within the system may require service. By monitoring the fore-mentioned discharge pressure, several system ailments may be identified.

These include any of the following;

1. Clogged condenser coil
2. Condenser fan not running
3. Clogged filter in the evaporator.
4. Evaporator/furnace blower not running or not running at the correct speed.
5. Expansion valve or orifice tube (depending on system design) is clogged or restricted.

One of the most common service points for an air conditioning system is cleaning the condenser coil, located outside. In normal operation, the interior air in the residence passes through a filter before it goes through the evaporator coil. In this scenario, the evaporator coil is typically exposed to fairly clean air, and less likely to become clogged and restrict airflow through the evaporator. The condensing unit, located outdoors, operates in a more hostile environment. The air that the condensing unit fan draws the condenser (hot) coils is unfiltered and carries all airborne particles that we find outdoors. This includes dirt, dust, pollen and airborne media from blooming flowers and trees. Left in this condition for a period of time, the entire system will have to work longer and harder to cool the residence. If the clogged condenser coils are not cleaned, to permit unrestricted movement of air through the condenser coils, the discharge pressure of the system will increase, the compressor will run hotter and the compressor in the condensing unit will eventually fail.

When the air conditioning system is running, the present invention continuously monitors the discharge pressure from the compressor, which is located within the condenser housing. As air flow through the condensing coil or evaporator coil becomes restricted, the expansion valve or orifice tube becomes clogged, or the circulating fan in the condenser or the evaporator fails, the discharge pressure from the compressor steadily increases. As pressure increases, the control module of the present invention provides system status data on the display panel that is mounted next to the interior thermostat that controls the outside condenser. The display will provide early warnings that discharge pressure in getting abnormally high. When the condenser discharge pressure increases to dangerous levels, the present invention will provide data on the system display to warn the home owner that the air conditioning system needs immediate attention. An optional feature of the preferred embodiment of the present invention is to automatically turn the air conditioning system off when the discharge pressure reaches a harmful level.

### BRIEF SUMMARY OF THE INVENTION

The present invention is a solid state monitoring system that continuously monitors the discharge pressure of chemical based air conditioning systems. The objective of this invention is to provide, to the property owner, early warning that the air conditioning system need professional service. With such an early warning, the home owner may perform simple inspections that include a) cleaning the condenser coil, b) inspecting the furnace filter, c) inspecting the condenser and evaporator fans to determine if they are running, d) inspect the evaporator fan to see if the fan drive belt is slipping. In many cases, the only service that is required is for the home owner to flush debris from the coils of the condenser, located outside the residence, with a garden hose. A fairly simple task.

The present invention consists of three components. The first is a pressure sensor that is installed in the high pressure, discharge line of the compressor, located within the enclosure of the condensing unit. The second component is the main control module that is also installed within the condenser housing. The third component is an display module that is installed inside the residence, adjacent to the thermostat that is controlling the compressor, located within the condensing unit, which is located external to the structure.

When the discharge pressure of the compressor begins to increase from the normal operating pressure, the control module sends a signal to the display panel that is mounted next to the thermostat housing. As the pressure increases, over days or weeks, depending on outside conditions, information is provided on the display module to provide the homeowner an early warning that service is required.

The communication between the control module of the instant invention, located within the condenser housing, and the display panel mounted next to the thermostat is carried over the wiring between the thermostat and the compressor control relay located within the condenser housing. The ability to communicate this pressure data over pre-existing wiring will be a key benefit that provides easy and simple installation of the monitoring system.

### BRIEF DESCRIPTION OF DRAWINGS

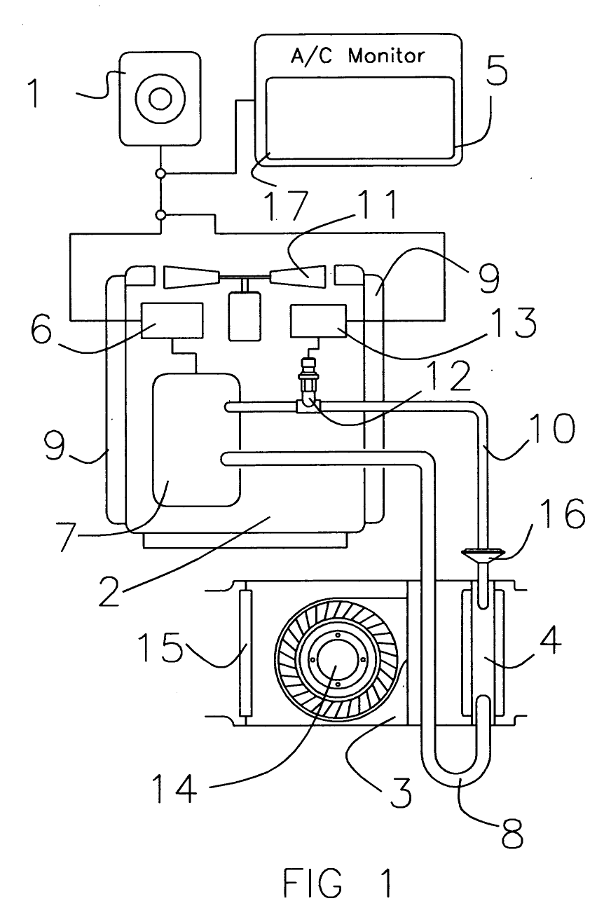

As shown in FIG. 1, an air conditioning system that includes the instant invention consists of a thermostat 1 that monitors the interior temperature of the dwelling, a condensing unit 2 that is located external to the dwelling, an evaporator housing 3 that recirculates air within the dwelling through the cold, evaporator coil 4 and the display of the invention 5 that provides an early warning that the air conditioning system requires service. If the home owner continues to operate the air conditioning system with unusually high discharge pressure, the system will consume an excessive amount of electricity to cool the dwelling. If the system is run for an extended period in this condition, the compressor will eventually fail, with the resulting high cost of compressor replacement.

### DETAILED DESCRIPTION OF THE INVENTION

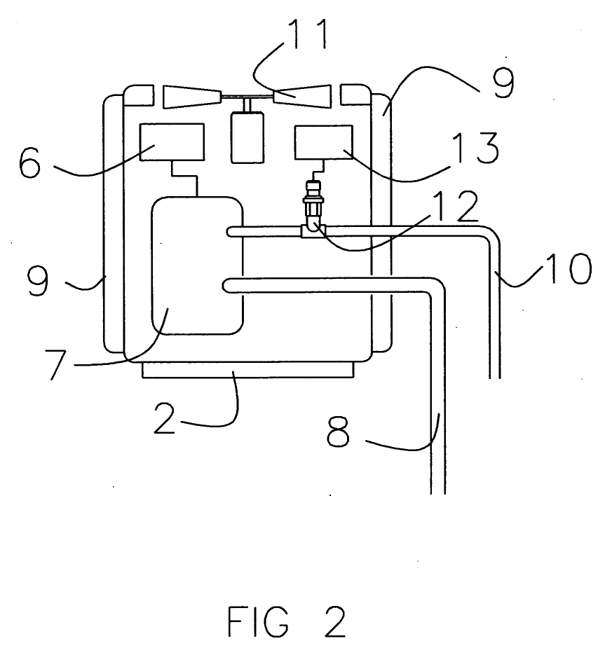

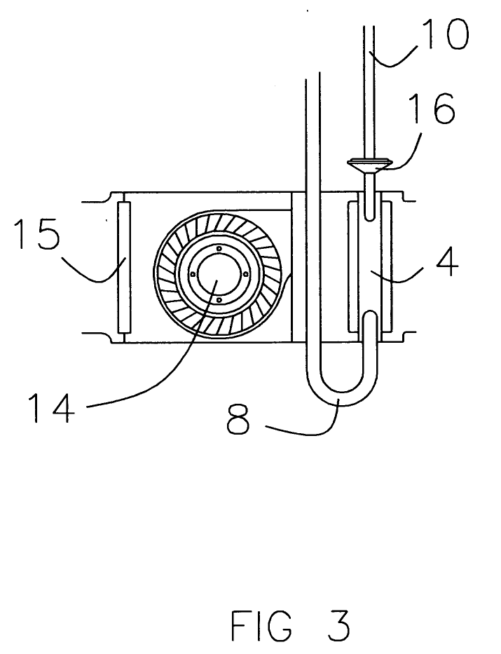

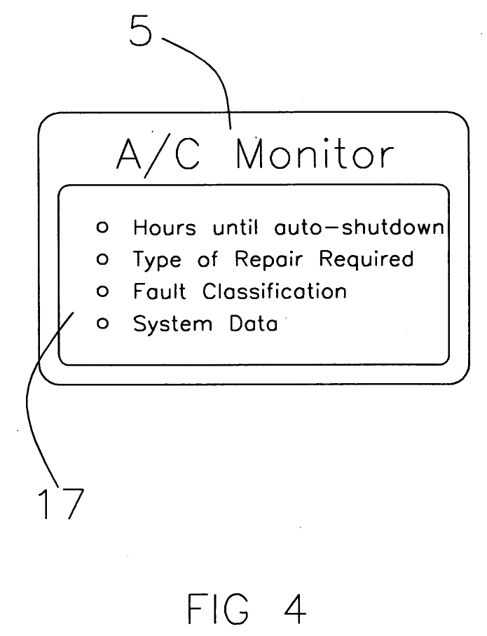

As shown in FIG. 2, the condensing unit 2 that is mounted external to the dwelling consists of a control 6 that is wired in communication to the thermostat that is installed within the dwelling, a compressor 7 that pumps gaseous refrigerant from the dwelling, via suction line 8, thru the condensing coils 9 within the condensing module, and returns liquid refrigerant to the dwelling via pressure line 10. The fan 11 circulates outside air through the condensing coils 9, which reduces the temperature of the gaseous refrigerant. The combination of temperature reduction through the coils, and compression of the gas by the compressor 7, yields a refrigerant in a liquid state, that may be circulated to the evaporator module 3, shown in FIG. 3. A key component of the instant invention is the pressure sensor 12, located in the high pressure refrigerant discharge line 10 from the condenser module. The control module 13 monitors the pressure in this discharge line and relays the status information to the monitoring system display that is co-located with the thermostat within the dwelling.

In FIG. 3, the evaporator module 3, mounted within the dwelling is described. The fan 14 draws warm air from within the dwelling via ductwork from the various rooms in the dwelling to the evaporator module 3. The warm air is drawn through the evaporator filter 15 and forced through the evaporator coil 4. Regulation of refrigerant flow through the evaporator coil is regulated by an orifice tube 16 or expansion valve 16.

Referring again to FIG. 1, under normal operating conditions, the control module 13, located within the condenser housing 2, monitors discharge pressure via the pressure sensor 12. As air flow through the condenser coils 9 or evaporator coil 4 is reduced, or refrigerant flow into the evaporator coil is reduced, the discharge pressure in the high pressure line 10 increases. This increase in pressure is recognized by the invention's control module 13 and its pressure sensor 12, which is positioned within the discharge line. When the monitoring system control 13 of the instant invention recognizes that the discharge pressure is increasing, above normal pressure levels, it illuminates the appropriate LED 17 on the face of the display module 5 located within the dwelling and adjacent to the thermostat 1. The communication between the invention's control module 13 and the display module 5 is transmitted over the wiring that the thermostat 1 uses to communicate to the condenser control module 6.

Listing of system components referenced in FIGS. 1 thru 4
1. Thermostat
2. Condenser
3. Evaporator
4. Evaporator coil
5. Display module
6. Condenser control
7. Compressor
8. Suction line
9. Condenser coil
10. Compressor discharge line
11. Condenser fan
12. Pressure Sensor
13. Monitor control of instant invention
14. Evaporator fan
15. Evaporator filter
16. Expansion Valve
17. Display

The embodiment of the invention in which an exclusive property or privilege is claimed is defined as follows:

1) An air conditioning system fault detection system that provides early warning to the home owner or resident that faults are being detected within the air conditioning system. The monitoring system consists of:
a) a pressure switch in the discharge line of the condenser,
b) a micro-processor based control module to collect a variable output from the pressure switch, process the data, and relay fault data to the interior-mounted display module,
c) a display module co-located with the thermostat that is installed within the dwelling,
d) a communication link between the control module of the instant invention that is located within the condenser housing and the data display that is co-located with the thermostat in the interior of the dwelling.

2) The microprocessor based control module of claim 1 will communicate to the display via the existing control wire between the thermostat and the condenser.

3) The display module of claim 1 will provide fault data to the resident or property owner providing early warning that there a one or more operational faults within the air conditioning system. This display will provide a sequence of instructions to alert the homeowner or resident that the air conditioning system requires service.
